(19) United States
(12) Patent Application Publication
(10) Pub. No.: US 2026/0165515 A1
(43) Pub. Date: Jun. 18, 2026

(54) LIQUID DOSING BOTTLE

(71) Applicant: YUANZONG XIAN, Yangjiang (CN)

(72) Inventor: YUANZONG XIAN, Yangjiang (CN)

(21) Appl. No.: 19/086,748

(22) Filed: Mar. 21, 2025

(30) Foreign Application Priority Data
Dec. 17, 2024 (CN) 202411863421.7

(51) Int. Cl. A47G 19/18; G01F 11/28

(52) U.S. Cl. CPC A47G 19/18; G01F 11/28

(57) ABSTRACT

Disclosed is a liquid dosing bottle, including a bottle body, a bottle cap, and an air conduit arranged in an inner cavity of the bottle body, the bottle cap includes a dosing chamber, a siphon, and an air vent, a bottom plate of the dosing chamber is provided with a liquid inlet hole, and a top plate of the dosing chamber is provided with a liquid outlet; the siphon is arranged in the dosing chamber, and includes a liquid inlet tube, a liquid outlet tube, and a connecting portion of the liquid inlet tube and the liquid outlet tube, a liquid inlet end of the liquid inlet tube is positioned near the top plate of the dosing chamber, an upper end of the air vent is communicated with atmosphere, and a lower end of the air vent is positioned at a lower part of the dosing chamber.

### CROSS-REFERENCE TO RELATED APPLICATIONS

This application claims priority to Chinese Patent Application No. 202411863421.7, filed on Dec. 17, 2024, which is hereby incorporated by reference in its entirety.

### TECHNICAL FIELD

The present disclosure relates to a container for containing liquid, and particularly relates to a liquid dosing bottle.

### BACKGROUND

Oil bottles are commonly used as kitchen utensils. Nowadays, people pay more attention to refined diet, and health-conscious individuals strictly control their intake of edible oil. Due to lacking an effective oil control mechanism, a traditional oil bottle is hard to dispense oil accurately, which affects healthy dietary plans and follow a trend of refined management of oil control.

The Chinese Patent number (Application No.: CN202121796498.9) discloses an oil pot, which includes a pot body and a pot lid connected to the pot body, the pot lid is provided with a pot spout that extends upward, an oil pouring port is formed at a top of the pot spout, a dosing chamber is inserted into the pot lid below the pot spout, the dosing chamber has a dosing chamber oil nozzle inserted into the pot spout, a partition plate is arranged inside the dosing chamber, the partition plate divides the dosing chamber into a first chamber and a second chamber, the dosing chamber oil nozzle is located inside the first chamber and the partition plate is located and seals a bottom of the dosing chamber oil nozzle, the partition plate is provided with a first through hole that communicates the second chamber with the dosing chamber oil nozzle, and a second through hole that communicates the first chamber with the second chamber, and an oil inlet is formed on a side wall of the first chamber. The invention patent enables controlled dispensing of liquid from the pot. However, in order to pour out a precise volume of liquid, the oil pot needs to be tilted twice, which is not very convenient.

### SUMMARY

A technical problem to be solved by the present disclosure is to provide a liquid dosing bottle capable of dispensing a precise amount of liquid with a single pouring.

In order to solve the above technical problem, the present disclosure adopts the following technical solution: a liquid dosing bottle, including a bottle body, a bottle cap, and an air conduit, where the air conduit is arranged in an inner cavity of the bottle body, and a lower end of the air conduit is positioned near a bottom surface of the inner cavity of the bottle body; the bottle cap includes a dosing chamber, a siphon, and an air vent, a bottom plate of the dosing chamber is provided with a liquid inlet hole that is communicated with the dosing chamber and the inner cavity of the bottle body, a top plate of the dosing chamber is provided with a liquid outlet; the siphon is arranged in the dosing chamber and includes a liquid inlet tube, a liquid outlet tube, and a connecting portion of the liquid inlet tube and the liquid outlet tube, an upper end of the liquid outlet tube is connected to the liquid outlet, a liquid inlet end of the liquid inlet tube is positioned near the top plate of the dosing chamber; the connecting portion near the bottom plate of the dosing chamber includes a vent tube, and the vent tube is connected to an upper end of the air conduit; and an upper end of the air vent is communicated with atmosphere, and a lower end of the air vent is positioned at a lower part of the dosing chamber.

In the liquid dosing bottle described above, the siphon is a telescopic tube, where the liquid outlet tube of the siphon is inserted into the liquid inlet tube, and an inner diameter of the liquid inlet tube is larger than an outer diameter of the liquid outlet tube; a lower end of the liquid outlet tube is positioned near a bottom of the liquid inlet tube, the bottom of the liquid inlet tube serves as the connecting portion and is provided with the vent tube; the vent tube is fixed to the bottom plate of the dosing chamber, an opening is formed on a bottom surface of the bottom plate, and the upper end of the air conduit is inserted into an inner bore of the vent tube through the opening.

In the liquid dosing bottle described above, an axis of the liquid outlet tube is obliquely intersected with a main axis of the bottle body, the liquid inlet hole is located on an inclined side of the liquid outlet tube, and the air vent is located on a side away from the inclined side of the liquid outlet tube; and both the liquid inlet hole and the air vent are through holes with a drop-shaped cross section.

In the liquid dosing bottle described above, an intersection angle between the axis of the liquid outlet tube and the main axis of the bottle body is 25°-35°; and a distance between the lower end of the liquid outlet tube and a bottom surface of the liquid inlet tube is 2-3 mm.

In the liquid dosing bottle described above, the bottle cap includes a cap body and a dosing chamber body, the cap body includes a receiving hole for accommodating the dosing chamber body, and the dosing chamber body is installed in the receiving hole; the dosing chamber is arranged in the dosing chamber body, the bottom plate of the dosing chamber is a bottom plate of the dosing chamber body, and the top plate of the dosing chamber is a top plate of the dosing chamber body; and the top plate of the dosing chamber body is provided with a boss that protrudes downward in the dosing chamber, and the air vent passes through the boss.

In the liquid dosing bottle described above, the axis of the liquid outlet tube is inclined longitudinally, the bottle cap includes two elastic latches, and the two elastic latches are separated in a transverse direction and arranged symmetrically; each of the elastic latches includes a latch and a compression spring, the latch includes a button and a latch hook, the latch hook is arranged below the button, a hook head of the latch hook faces outward, and an inner side of the button is provided with a spring seat; the dosing chamber body includes a latch mounting groove corresponding to the latch, and an upper part of the latch mounting groove includes a button hole; the latch and the compression spring are arranged in the latch mounting groove, the button of the latch is arranged in the button hole, a gap is formed between an inner side of the latch and a groove bottom of the latch mounting groove, the compression spring is installed between the groove bottom of the latch mounting groove and the spring seat of the button, an inner wall of the receiving hole of the cap body includes a slot corresponding to the latch hook of the latch, and the latch hook of the latch hooks an upper edge of the slot.

In the liquid dosing bottle described above, an annular groove is formed at an outer periphery of a lower part of the dosing chamber body, an elastic sealing ring is installed in the annular groove, and the lower part of the dosing chamber body and the receiving hole of the cap body are sealed through the elastic sealing ring; and a lower end of the dosing chamber is provided with a bottom plate receiving hole, the bottom plate is installed in the bottom plate receiving hole and is in interference fit with the bottom plate receiving hole.

In the liquid dosing bottle described above, the bottle cap includes a cover plate and a strip-shaped gravity flip cover, where the top plate is provided with a liquid spout that protrudes outward, the liquid spout includes the liquid outlet, and an inclination angle of the liquid outlet is the same as an inclination angle of the liquid outlet tube; an upper part of the dosing chamber body includes a cylindrical side wall, a top end of the cylindrical side wall is higher than the top plate, and the cover plate is snap-fitted to the upper end of the cylindrical side wall; and the cover plate is provided with a hinged cover hole, the gravity flip cover is arranged in the hinged cover hole, and the gravity flip cover is hinged to the cover plate.

In the liquid dosing bottle described above, the button hole of the latch mounting groove is formed on the cylindrical side wall, an upper end of the latch mounting groove is open, and an opening at the upper end of the latch mounting groove serves as an entrance for installing the latch; and the opening at the upper end of the latch mounting groove is sealed by the cover plate, and a gap between an upper end of the button and the cover plate in an axis direction of the compression spring is smaller than a gap between a lower end of the latch and the groove bottom of the latch mounting groove.

A liquid discharge process of the liquid dosing bottle described above includes the following working steps:
(1) the liquid dosing bottle is inverted, such that the liquid outlet tube of the siphon is vertically downward, liquid in the inner cavity of the bottle body then flows into the dosing chamber through the liquid inlet hole on the bottom plate; at the same time, air enters through the liquid outlet tube of the siphon, and flows into a space above the liquid in the inner cavity of the bottle body via the air conduit, and fills vacuum generated by the liquid that flows out of the inner cavity of the bottle body; and air above a liquid surface in the dosing chamber flows out from the air vent on the top plate due to a reduced space caused by inflow of the air;
(2) a liquid level in the dosing chamber gradually rises; when the liquid enters the connecting portion from the liquid inlet tube of the siphon, the liquid in the connecting portion blocks an air passage between the liquid outlet tube and the air conduit, the air does not enter the inner cavity of the bottle body any longer, and vacuum is formed above the liquid in the inner cavity of the bottle body, such that the liquid in the inner cavity of the bottle body stops flowing from the liquid inlet hole on the bottom plate into the dosing chamber;
(3) the liquid in the dosing chamber flows out from the liquid outlet tube of the siphon under the action of siphon, and the liquid level in the dosing chamber gradually decreases, such that the space vacated by the liquid in the dosing chamber is replenished by air flowing in through the air vent;
(4) when the liquid level in the dosing chamber drops to an inlet position of the liquid inlet tube of the siphon, siphon action ceases, and the liquid outlet tube of the siphon stops dispensing liquid; and a volume of liquid dispensed by the liquid dispenser bottle at one time is equivalent to a volume of liquid corresponding to a vertical distance of the dosing chamber from an entrance of the liquid inlet tube to a bottom of the liquid inlet tube; and
(5) when being kept in the inverted state, the liquid dosing bottle repeats the steps (1) to (4), and each cycle flows out a dosing volume of liquid; and the liquid dosing bottle can pour out an integer multiple of the dosing volume of liquid.

The liquid dosing bottle of the present disclosure can accurately fill the dosing chamber and dispense a dosing amount of liquid with a single pouring.

### BRIEF DESCRIPTION OF DRAWINGS

The present disclosure is further described in detail in combination with drawings and detailed description of the examples as below.

FIG. 1 is a perspective view of an oil dosing bottle according to Embodiment 1 of the present disclosure.

FIG. 2 is a top view of an oil dosing bottle according to Embodiment 1 of the present disclosure.

FIG. 3 is an exploded view of an oil dosing bottle according to Embodiment 1 of the present disclosure.

FIG. 4 is a sectional view of A-A in FIG. 2.

FIG. 5 is a sectional view of B-B in FIG. 2.

FIG. 6 is a schematic diagram of a bottle body of Embodiment 1 of the present disclosure pouring oil into a dosing chamber.

FIG. 7 is a schematic diagram of a dosing chamber of Embodiment 1 of the present disclosure being filled in with dosing oil.

FIG. 8 is a schematic diagram of a dosing chamber of Embodiment 1 of the present disclosure starting to pour out oil.

FIG. 9 is a schematic diagram of a dosing chamber of Embodiment 1 of the present disclosure stopping pouring out oil.

FIG. 10 is a sectional view of an oil dosing bottle according to Embodiment 2 of the present disclosure.

### DESCRIPTION OF EMBODIMENTS

### Embodiment 1

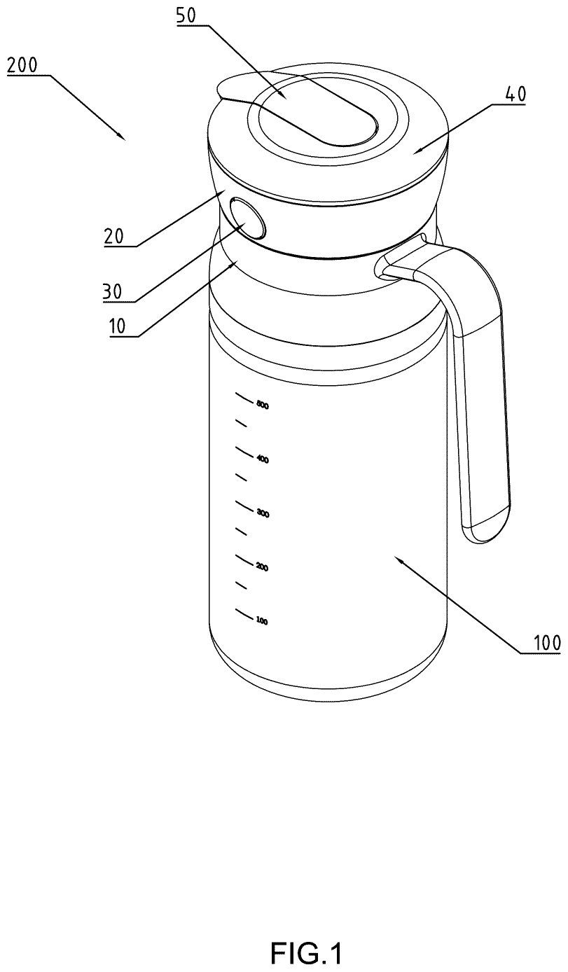

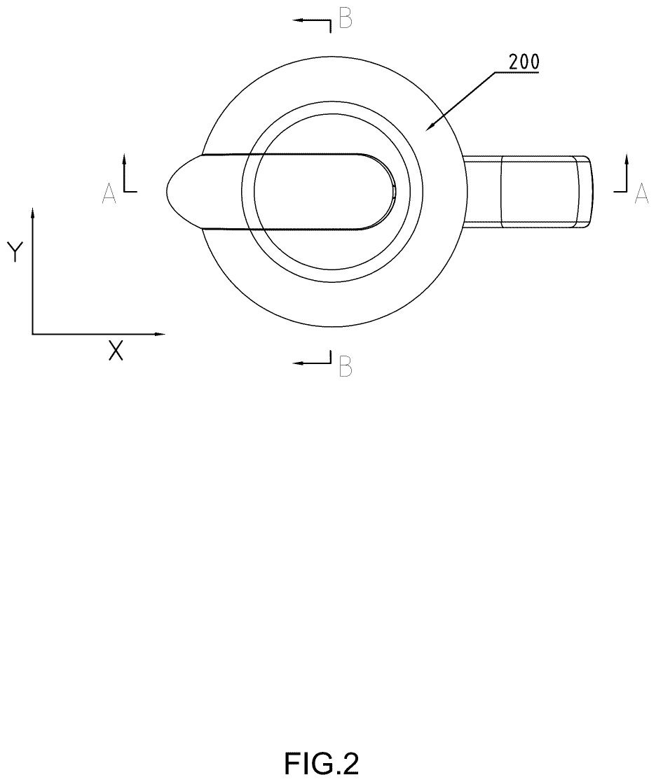

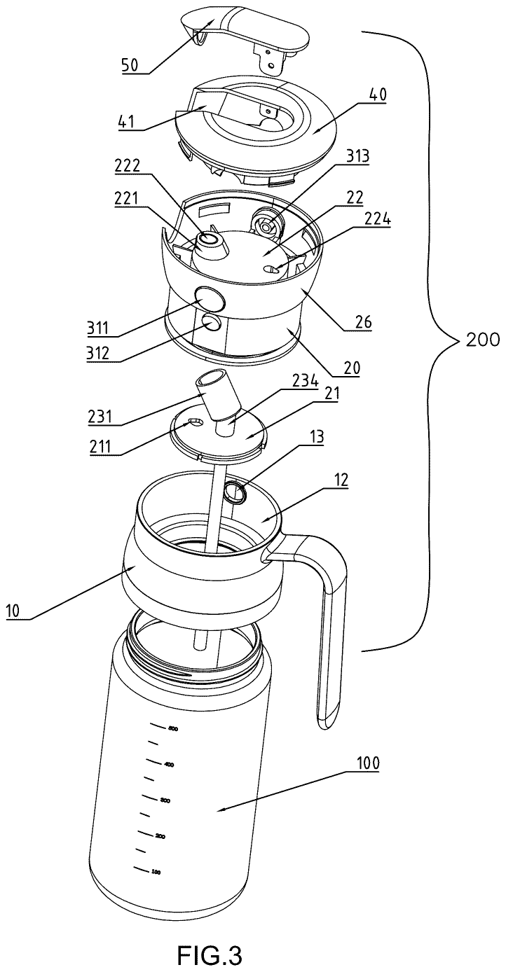

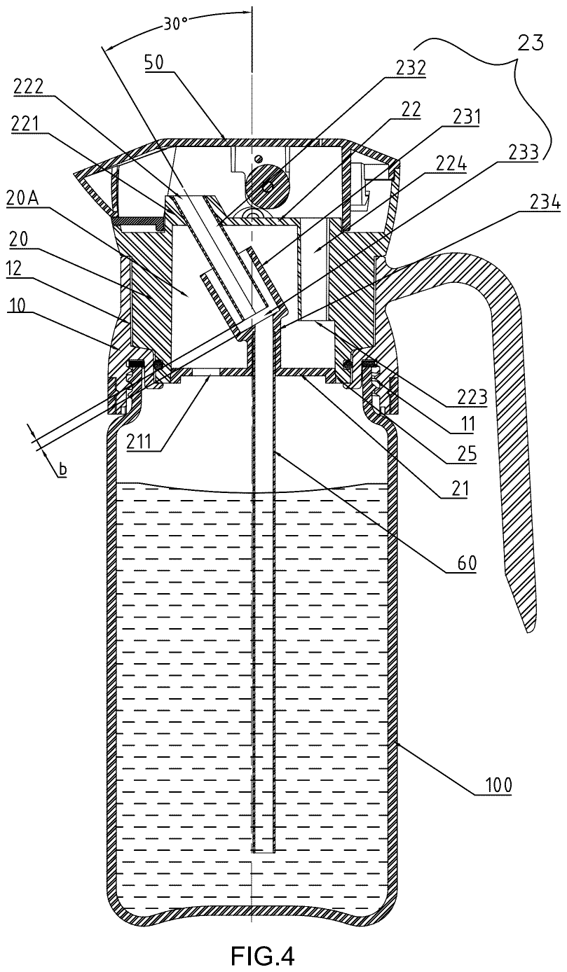

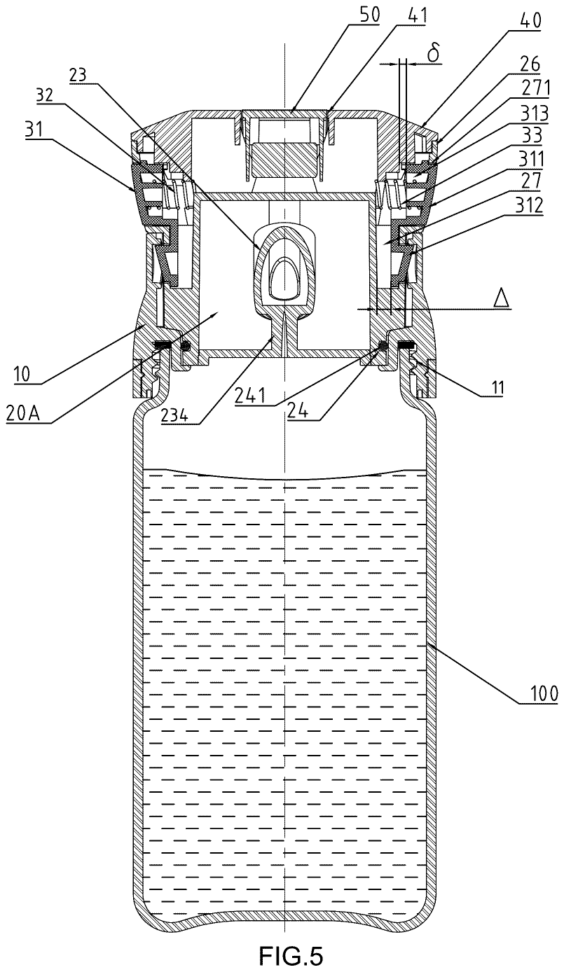

Structure and working principle of an oil dosing bottle in Embodiment 1 of the present disclosure are shown in FIGS. 1-9, and the oil dispenser bottle includes a glass bottle body 100 and a bottle cap 200.

The bottle cap 200 includes a cap body 10, a dosing chamber body 20, two elastic latches 30, a cover plate 40, and a strip-shaped gravity flip cover 50. A lower part of the cap body 10 includes internal threads 11 connected to the glass bottle body 100, an upper part of the cap body 10 has a receiving hole 12 for accommodating the dosing chamber body 20, and the dosing chamber body 20 is installed in the receiving hole 12. A cavity inside the dosing chamber body 20 is a dosing chamber 20A, a bottom plate 21 of the dosing chamber body 20 also serves as a bottom plate of the dosing chamber 20A, and a top plate 22 of the dosing chamber body 20 also serves as a top plate of the dosing chamber 20A.

The bottom plate 21 of the dosing chamber body 20 is provided with an oil inlet hole 211 that is communicated with the dosing chamber 20A and an inner cavity of the glass bottle body 100, and the top plate 22 of the dosing chamber body 20 is provided with an oil spout 221 that protrudes outward, and an oil outlet 222 is formed inside the oil spout 221.

A siphon 23 is disposed inside the dosing chamber body 20, the siphon 23 includes an oil inlet tube 231, an oil outlet tube 232, and a connecting portion 233 of the oil inlet tube 231 and the oil outlet tube 232.

In this embodiment, the siphon 23 is a telescopic tube, and an oil inlet end of the oil inlet tube 231 is positioned near the top plate 22 of the dosing chamber body 20. The oil outlet tube 232 of the siphon 23 is inserted into the oil inlet tube 231 from the oil inlet end of the oil inlet tube 231, and an inner diameter of the oil inlet tube 231 is larger than an outer diameter of the oil outlet tube 232. An upper end of the oil outlet tube 232 is connected to the oil outlet 222, a lower end of the oil outlet tube 232 is positioned near a bottom of the oil inlet tube 231, a bottom of the oil inlet tube 231 serves as the connecting portion 233 and is provided with a vent tube 234, and the vent tube 234 is communicated with a cavity in the connecting portion 233. The vent tube 234 is fixed to the bottom plate 21 of the dosing chamber body 20, an opening is formed on a bottom surface of the bottom plate 21, an upper end of the air conduit 60 is inserted into an inner bore of the vent tube 234 through the opening, a main body of the air conduit 60 is vertically arranged in the inner cavity of the glass bottle body 100, and a lower end of the air conduit 60 is positioned near a bottom surface of the inner cavity of the glass bottle body 100.

The dosing chamber 20A is provided with an air vent 224 that is communicated with atmosphere. The top plate 22 of the dosing chamber body 20 is provided with a boss 223 that protrudes downward in the dosing chamber 20A, and the vertically arranged air vent 224 passes through the boss 223. An opening at an upper end of the air vent 224 is communicated with the atmosphere, and an opening at a lower end of the air vent 224 is located at a lower part of the dosing chamber 20A.

An axis of the oil outlet tube 232 is inclined in a longitudinal direction (X direction), the axis of the oil outlet tube 232 is obliquely intersected with a main axis of the glass bottle body 100, the oil inlet hole 211 is located on an inclined side of the oil outlet tube 232, and the air vent 224 is located on a side on the inclined side of the oil outlet tube 232. Both the oil inlet hole 211 and the air vent 224 are through holes with a drop-shaped cross section. Compared with a circular through holes, the drop-shaped through hole allows for a smoother flow, prevents bubble formation, and is less prone to clogging.

In this embodiment, an intersection angle between the axis of the oil outlet tube 232 and the main axis of the glass bottle body 100 is 30°, the upper end of the oil outlet tube 232 is inserted into the oil outlet 222, and an inclination angle of the oil outlet 222 is the same as an inclination angle of the oil outlet tube 232. A distance (b) between the lower end of the oil outlet tube 232 and a bottom surface of the oil inlet tube 231 is 2-3 mm.

An annular groove 24 is formed at an outer periphery of a lower part of the dosing chamber body 20, an elastic sealing ring 241 is installed in the annular groove 24, and the lower part of the dosing chamber body 20 and the receiving hole 12 of the cap body 10 are sealed through the elastic sealing ring 241.

The lower end of the dosing chamber 20A is provided with a bottom plate accommodating hole 25, the bottom plate 21 is installed in the bottom plate accommodating hole 25 and is in interference fit with the bottom plate accommodating hole 25.

An upper part of the dosing chamber body 20 includes a circle of cylindrical side wall 26, a top end of the cylindrical side wall 26 is higher than the top plate 22, and an edge of the cover plate 40 is snap-fitted to the upper end of the cylindrical side wall 26. The cover plate 40 is provided with a hinged cover hole 41 for easy oil dispensing, the gravity flip cover 50 is arranged in the hinged cover hole 41, and a rear part of the gravity flip cover 50 is hinged to the cover plate 40.

The two elastic latches 30 are separated in a transverse direction (Y-axis direction) and arranged symmetrically. Each of the elastic latches 30 includes a latch 31 and a compression spring 33, the latch 31 includes a button 311 and a latch hook 312, the latch hook 312 is located below the button 311, a hook head of the latch hook 312 faces outward, and an inner side of the button 311 is provided with a spring seat 313. The dosing chamber body 20 includes a latch mounting groove 27 corresponding to the latch 31, and an upper part of the latch mounting groove 27 includes a button hole 271. The latch 31 and the compression spring 33 are arranged in the latch mounting groove 27, a button 311 of the latch 31 is arranged in the button hole 271, and a gap is formed between an inner side of the latch 31 and a groove bottom of the latch mounting groove 27, such that the latch 31 can be pressed inward. The compression spring 33 is installed between the groove bottom of the latch mounting groove 27 and the spring seat 313 of the button 311, an inner wall of the receiving hole 12 of the cap body 10 includes a slot 13 corresponding to the latch hook 312 of the latch, and the latch hook 312 of the latch 31 hooks an upper edge of the slot 13.

The button hole 271 of the latch mounting groove 27 is formed on the cylindrical side wall 26, an upper end of the latch mounting groove 27 is open, and an opening at the upper end of the latch mounting groove 27 serves as an entrance for installing the latch 31. An opening at the upper end of the latch mounting groove 27 is sealed by the cover plate 40, and a gap (δ) between an upper end of the button 311 and the cover plate 40 in an axis direction of the compression spring 33 is smaller than a gap (Δ) between a lower end of the latch 31 and the groove bottom of the latch mounting groove 27. When the button 311 is pressed, the lower end of the latch 31 swings inward, the latch hook 312 is disengaged from the slot 13, in which case, the dosing chamber body 20 can be removed from the receiving hole 12.

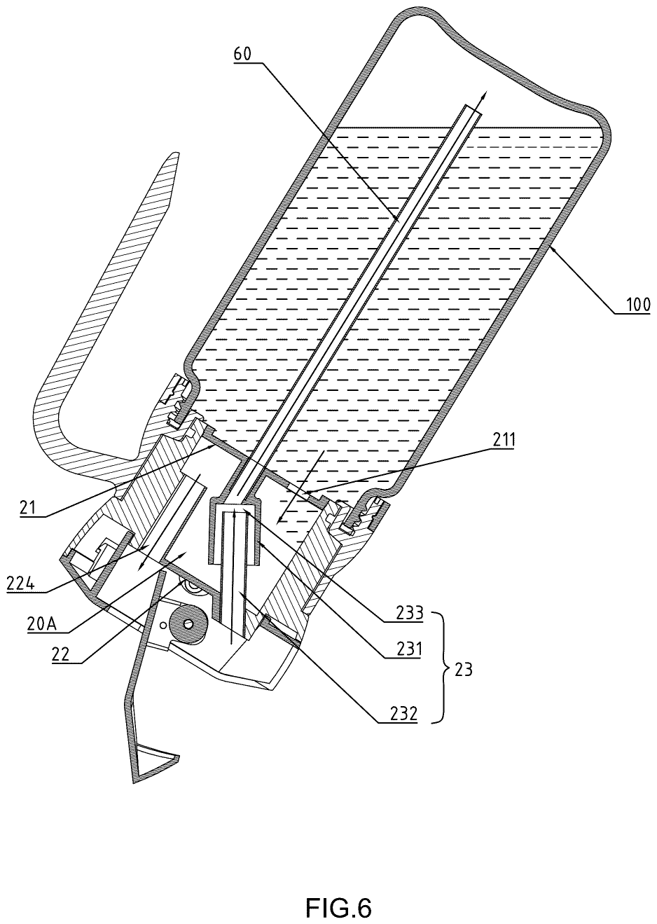

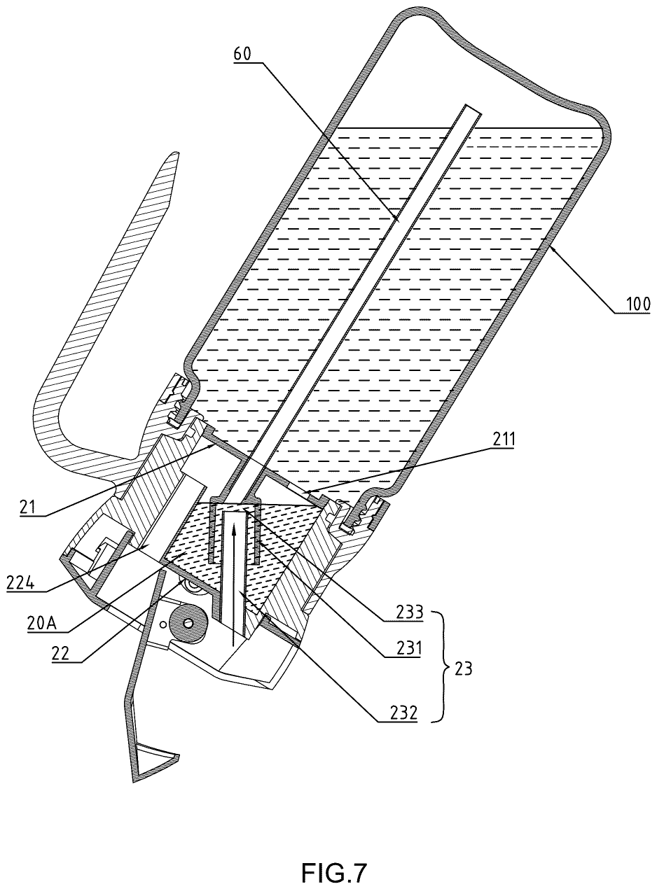

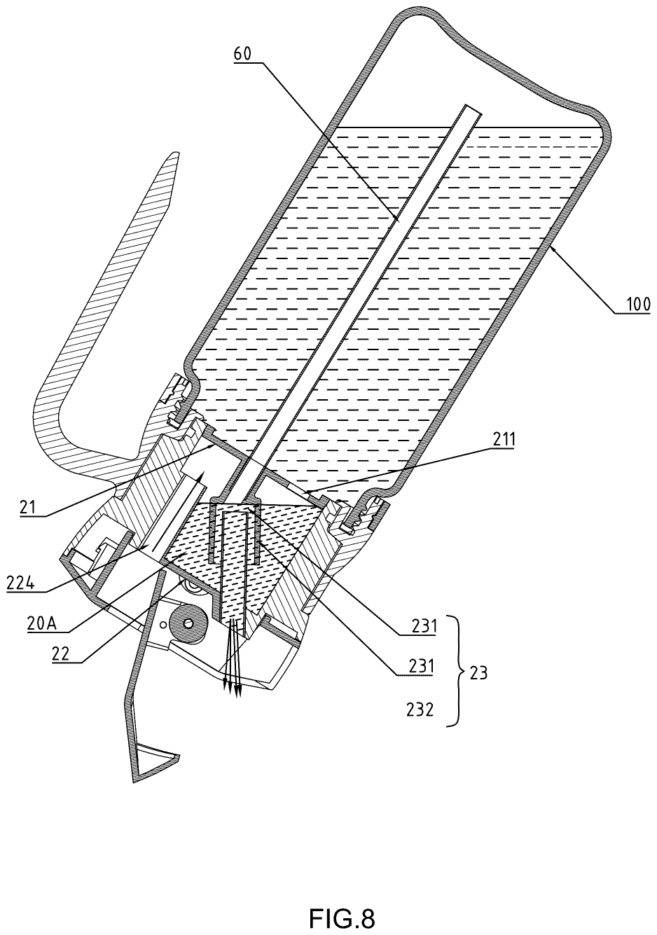

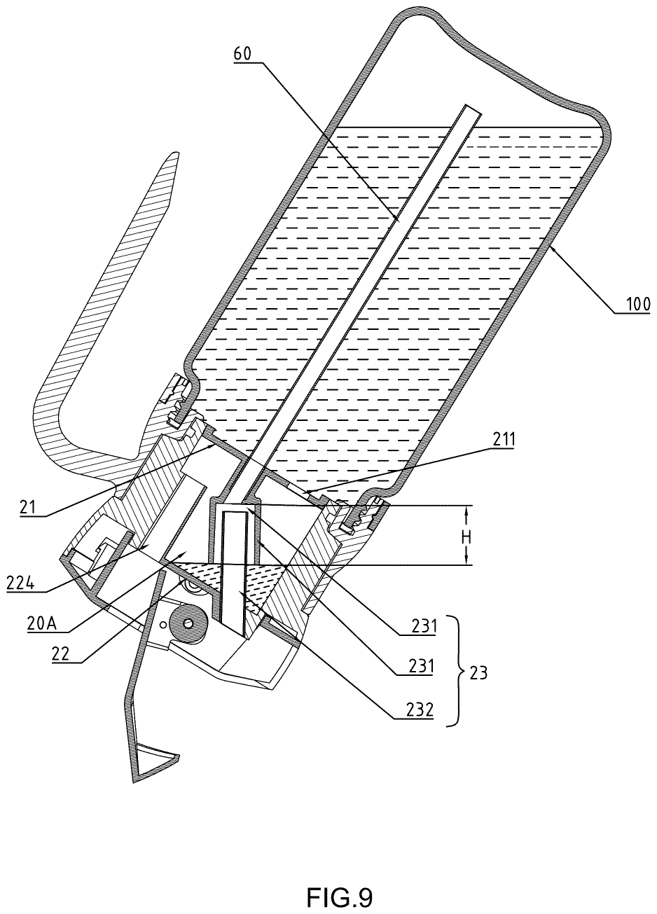

Working principle of oil pouring by the oil dosing bottle in Embodiment 1 of the present disclosure are shown in FIGS. 6-9, including the following working steps:
(1) as shown in FIG. 6, the oil dosing bottle is tilted (inverted) in a longitudinal direction (X-axis direction), such that the oil outlet tube 232 of the siphon 23 is vertically downward, in which case, oil in the inner cavity of the glass bottle body 100 flows into the dosing chamber 20A through the oil inlet hole 211 on the bottom plate 21. At the same time, air enters through the oil outlet tube 232 of the siphon 23, and flows into a space above the oil in the inner cavity of the glass bottle body 100 via the air conduit 60, and fills vacuum generated by the oil flowing out of the inner cavity of the glass bottle body 100; and air above a liquid surface in the dosing chamber 20A flows out from the air vent 224 on the top plate 22 due to a reduced space caused by inflow of the air.
(2) As shown in FIG. 7, a liquid level in the dosing chamber 20A gradually rises; when the oil enters the connecting portion 233 from the oil inlet tube 231 of the siphon 23, the oil in the connecting portion 233 blocks an air passage between the oil outlet tube 232 and the air conduit 60, the air does not enter the inner cavity of the glass bottle body 100 any longer, and the vacuum is formed above the oil in the inner cavity of the glass bottle body 100, such that the oil in the inner cavity of the glass bottle body 100 stops flowing from the oil inlet hole 211 on the bottom plate 21 into the dosing chamber 20A.
(3) As shown in FIG. 8, since the space above the liquid level in the dosing chamber 20A is communicated with the atmosphere through the air vent 224, the oil in the dosing chamber 20A flows out through the oil outlet tube 232 of the siphon 23 under the action of siphon, and the liquid level in the dosing chamber 20A gradually decreases, such that the space vacated by the oil in the dosing chamber 20A is replenished by air flowing in through the air vent 224.
(4) As shown in FIG. 9, when the liquid level in the dosing chamber 20A drops to an inlet position of the oil inlet tube 231 of the siphon, siphon action ceases, and the oil outlet tube 232 of the siphon 23 stops dispensing oil; and a volume of oil dispensed by the oil dispenser bottle at one time is equivalent to an volume of oil corresponding to a vertical distance (H) of the dosing chamber 20A from an entrance of the oil inlet tube 231 to a bottom of the oil inlet tube 231.
(5) When a measured amount at the one time is sufficient, the oil dispenser bottle can be returned to an upright position to stop further dispensing. When additional oil is needed, the oil dispenser bottle can continue to be kept in the tilted (inverted) state, and the oil dispenser bottle will repeat the steps (1) to (4). Each cycle flows out a volume of oil corresponding to the vertical distance (H) shown in FIG. 9, and the oil dispenser bottle can pour out an integer multiple of the preset dosing amount of oil by one single tilting.

### Embodiment 2

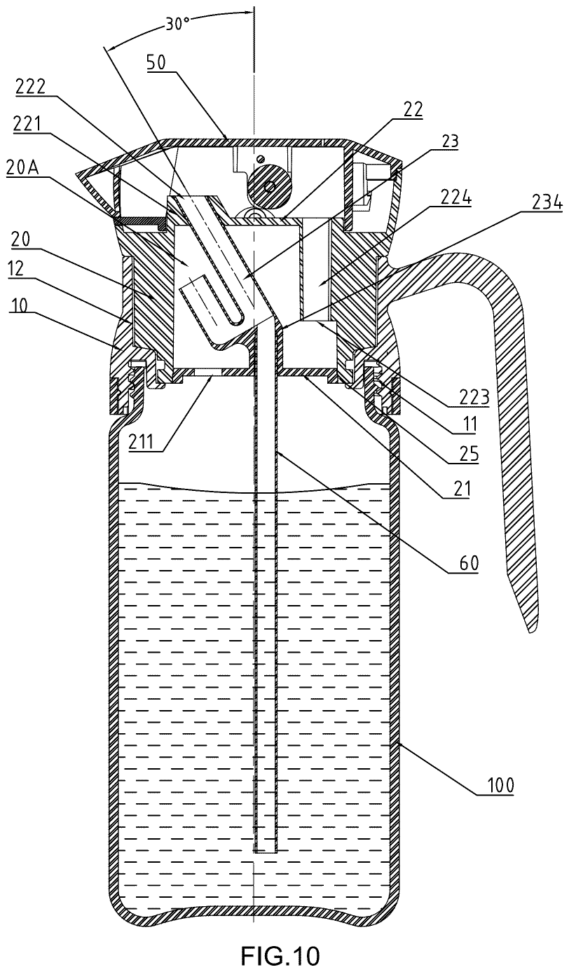

A structure of Embodiment 2 of the present disclosure is shown in FIG. 10. The difference between Embodiment 2 and Embodiment 1 only lies in that the siphon 23 is replaced by a U-shaped bent tube, which is the telescopic tube in Embodiment 1. The working principle and other structures of Embodiment 2 are exactly the same as those of Embodiment 1.

What is claimed is:

1. A liquid dosing bottle, comprising a bottle body, a bottle cap, and an air conduit, wherein the air conduit is arranged in an inner cavity of the bottle body, and a lower end of the air conduit is positioned near a bottom surface of the inner cavity of the bottle body; the bottle cap comprises a dosing chamber, a siphon, and an air vent, a bottom plate of the dosing chamber is provided with a liquid inlet hole that is communicated with the dosing chamber and the inner cavity of the bottle body, a top plate of the dosing chamber is provided with a liquid outlet; the siphon is arranged in the dosing chamber, and comprises a liquid inlet tube, a liquid outlet tube, and a connecting portion of the liquid inlet tube and the liquid outlet tube, an upper end of the liquid outlet tube is connected to the liquid outlet, a liquid inlet end of the liquid inlet tube is positioned near the top plate of the dosing chamber; the connecting portion near the bottom plate of the dosing chamber comprises a vent tube, and the vent tube is connected to an upper end of the air conduit; and an upper end of the air vent is communicated with atmosphere, and a lower end of the air vent is positioned at a lower part of the dosing chamber.

2. The liquid dosing bottle according to claim 1, wherein the siphon is a telescopic tube, the liquid outlet tube of the siphon is inserted into the liquid inlet tube, and an inner diameter of the liquid inlet tube is larger than an outer diameter of the liquid outlet tube; a lower end of the liquid outlet tube is positioned near a bottom of the liquid inlet tube, the bottom of the liquid inlet tube serves as the connecting portion and is provided with the vent tube; and the vent tube is fixed to the bottom plate of the dosing chamber, an opening is formed on a bottom surface of the bottom plate, and the upper end of the air conduit is inserted into an inner bore of the vent tube through the opening.

3. The liquid dosing bottle according to claim 2, wherein an axis of the liquid outlet tube is obliquely intersected with a main axis of the bottle body, the liquid inlet hole is located on an inclined side of the liquid outlet tube, and the air vent is located on a side away from the inclined side of the liquid outlet tube; and both the liquid inlet hole and the air vent are through holes with a drop-shaped cross section.

4. The liquid dosing bottle according to claim 3, wherein an intersection angle between the axis of the liquid outlet tube and the main axis of the bottle body is 25°-35°; and a distance between the lower end of the liquid outlet tube and a bottom surface of the liquid inlet tube is 2-3 mm.

5. The liquid dosing bottle according to claim 3, wherein the bottle cap comprises a cap body and a dosing chamber body, the cap body comprises a receiving hole for accommodating the dosing chamber body, and the dosing chamber body is installed in the receiving hole; the dosing chamber is arranged in the dosing chamber body, the bottom plate of the dosing chamber is a bottom plate of the dosing chamber body, and the top plate of the dosing chamber is a top plate of the dosing chamber body; and the top plate of the dosing chamber body is provided with a boss that protrudes downward in the dosing chamber, and the air vent passes through the boss.

6. The liquid dosing bottle according to claim 5, wherein the axis of the liquid outlet tube is inclined longitudinally, the bottle cap comprises two elastic latches, and the two elastic latches are separated in a transverse direction and arranged symmetrically; each of the elastic latches comprises a latch and a compression spring, the latch comprises a button and a latch hook, the latch hook is arranged below the button, a hook head of the latch hook faces outward, and an inner side of the button is provided with a spring seat; the dosing chamber body comprises a latch mounting groove corresponding to the latch, and an upper part of the latch mounting groove is provided with a button hole; the latch and the compression spring are arranged in the latch mounting groove, the button of the latch is arranged in the button hole, a gap is formed between an inner side of the latch and a groove bottom of the latch mounting groove, the compression spring is installed between the groove bottom of the latch mounting groove and the spring seat of the button, an inner wall of the receiving hole of the cap body is provided with a slot corresponding to the latch hook of the latch, and the latch hook of the latch hooks an upper edge of the slot.

7. The liquid dosing bottle according to claim 5, wherein an annular groove is formed at an outer periphery of a lower part of the dosing chamber body, an elastic sealing ring is installed in the annular groove, and the lower part of the dosing chamber body and the receiving hole of the cap body are sealed through the elastic sealing ring; and a lower end of the dosing chamber is provided with a bottom plate receiving hole, and the bottom plate is installed in the bottom plate receiving hole, and is in interference fit with the bottom plate receiving hole.

8. The liquid dosing bottle according to claim 6, wherein the bottle cap comprises a cover plate and a strip-shaped gravity flip cover, the top plate is provided with a liquid spout that protrudes outward, the liquid spout comprises the liquid outlet, and an inclination angle of the liquid outlet is the same as an inclination angle of the liquid outlet tube; an upper part of the dosing chamber body comprises a cylindrical side wall, a top end of the cylindrical side wall is higher than the top plate, and the cover plate is snap-fitted to the upper end of the cylindrical side wall; and the cover plate is provided with a hinged cover hole, the gravity flip cover is arranged in the hinged cover hole, and the gravity flip cover is hinged to the cover plate.

9. The liquid dosing bottle according to claim 5, wherein the button hole of the latch mounting groove is formed on the cylindrical side wall, an upper end of the latch mounting groove is open, and an opening at the upper end of the latch mounting groove serves as an entrance for installing the latch; and the opening at the upper end of the latch mounting groove is sealed by the cover plate, and a gap between an upper end of the button and the cover plate in an axis direction of the compression spring is smaller than a gap between a lower end of the latch and the groove bottom of the latch mounting groove.

10. The liquid dosing bottle according to claim 1, wherein a liquid discharge process of the liquid dosing bottle comprises the following working steps:
(1) the liquid dosing bottle is inverted, such that the liquid outlet tube of the siphon is vertically downward, liquid in the inner cavity of the bottle body then flows into the dosing chamber through the liquid inlet hole on the bottom plate; at the same time, air enters through the liquid outlet tube of the siphon, and flows into a space above the liquid in the inner cavity of the bottle body via the air conduit, and fills vacuum generated by the liquid that flows out of the inner cavity of the bottle body; and air above a liquid surface in the dosing chamber flows out from the air vent on the top plate due to a reduced space caused by inflow of the air;
(2) a liquid level in the dosing chamber gradually rises; when the liquid enters the connecting portion from the liquid inlet tube of the siphon, the liquid in the connecting portion blocks an air passage between the liquid outlet tube and the air conduit, the air does not enter the inner cavity of the bottle body any longer, and vacuum is formed above the liquid in the inner cavity of the bottle body, such that the liquid in the inner cavity of the bottle body stops flowing from the liquid inlet hole on the bottom plate into the dosing chamber;
(3) the liquid in the dosing chamber flows out from the liquid outlet tube of the siphon under the action of siphon, and the liquid level in the dosing chamber gradually decreases, such that the space vacated by the liquid in the dosing chamber is replenished by air flowing in through the air vent;
(4) when the liquid level in the dosing chamber drops to an inlet position of the liquid inlet tube of the siphon, siphon action ceases, and the liquid outlet tube of the siphon stops dispensing liquid; and a volume of liquid dispensed by the liquid dispenser bottle at one time is equivalent to a volume of liquid corresponding to a vertical distance of the dosing chamber from an entrance of the liquid inlet tube to a bottom of the liquid inlet tube; and
(5) when being kept in the inverted state, the liquid dosing bottle repeats the steps (1) to (4), and each cycle flows out a dosing volume of liquid; and the liquid dosing bottle can pour out an integer multiple of the dosing volume of liquid.
